(19) United States
(12) Patent Application Publication
(10) Pub. No.: US 2024/0386312 A1
(43) Pub. Date: Nov. 21, 2024

(54) TRAINING MACHINE LEARNING MODELS BASED ON FEATURE VALIDITY

(71) Applicant: Capital One Services, LLC, McLean, VA (US)

(72) Inventor: Govind ANAND, McLean, VA (US)

(73) Assignee: Capital One Services, LLC, McLean, VA (US)

(21) Appl. No.: 18/317,898

(22) Filed: May 15, 2023

(51) Int. Cl. G06N 20/00

(52) U.S. Cl. CPC G06N 20/00

(57) ABSTRACT

Methods and systems are described herein for training machine learning models based on feature validity. The system retrieves a feature generation log of feature generation statuses for generating features. Each status may indicate whether a corresponding attempt to generate a corresponding feature was successful. The system may generate a validity parameter for each feature based on successful generation attempts for each feature from the feature generation log. The system may assign a weight, with a dataset, to each feature based on the corresponding validity parameter for each feature. The system may then input the dataset into a machine learning model to train the machine learning model based on the weights of the features. The training routine may use the weights to indicate feature importance within the machine learning model.

### BACKGROUND

Prior to using a machine learning model, that machine learning model is often trained using multiple features. In particular, various training methods involve selecting features that the machine learning model will rely upon in making predictions. However, quality of feature data may degrade over time. For example, the processes responsible for generating the features may experience disruptions, delays, or failures. When a feature relied upon by a machine learning model loses its quality, the predictions generated by the machine learning model may no longer be reliably accurate. In many instances, systems are not able to monitor quality of these features over time once the features have been selected for training. As a result, machine learning models may generate inaccurate predictions due to reliance on invalid features.

### SUMMARY

Methods and systems are described herein for training machine learning models based on feature validity. A model training system may be built and configured to perform operations discussed herein. The model training system may retrieve a feature generation log detailing features selected to train a machine learning model and statuses reflecting the generation of those features. For example, each status may reflect an attempt to generate or update a feature and may indicate whether the attempt was successful. In some embodiments, the model training system may determine a set of the statuses to use for assessing a validity of each feature. For example, the model training system may determine the set of statuses for a given feature based on a frequency at which the model training system attempts to generate that feature. The model training system may then generate a validity parameter for each feature. For example, the validity parameter may indicate whether a corresponding feature has high validity, medium validity, low validity, or some other degree of validity. The model training system may determine the validity of a given feature by assessing the set of statuses for that feature and determining which statuses, out of the set, were successful. For example, the model training system may assess the ratio of successful to unsuccessful statuses, the portion of successful statuses, the relative timing of successful statuses, or other aspects of the set of statuses.

The model training system may assign a weight to each feature based on the validity parameter of each feature. For example, the model training system may assign higher weights to features having higher validity parameters. The model training system may assign the weights to the features within a dataset. In some embodiments, the model training system may remove features that are not valid enough from the dataset. For example, if a feature has a validity parameter that does not meet a threshold, the model training system may remove the feature from the dataset. The model training system may input the dataset into a training routine of a machine learning model to train the model. The dataset may be used to train the machine learning model to make predictions based on the degrees of the validity of the features. For example, the machine learning model may rely more heavily on features having higher weights and, as such, higher degrees of validity. Training the machine learning model using weights that are assigned based on the validity of the features enables the model training system to generate a machine learning model that is less reliant on less valid features. Accordingly, the resulting machine learning model may maintain a higher accuracy.

In particular, the model training system may retrieve a feature generation log or multiple feature generation logs detailing features selected to train a machine learning model. The feature generation log or logs may include feature generation statuses reflecting attempts to generate a plurality of features. For example, each feature generation status may indicate whether a corresponding attempt to generate a corresponding feature was successful. In some embodiments, the status may indicate, for unsuccessful attempts, a reason why the attempt was not successful. For example, the status may indicate an error or an error type associated with the unsuccessful attempt.

The model training system may determine a set of the statuses to use for assessing a validity of each feature. For example, each feature may be associated with a plurality of statuses, and the model training system may determine a subset of those statuses to use for validity assessment of that feature. In some embodiments, the model training system may determine the set of statuses for a given feature based on a frequency at which the model training system attempts to generate that feature. For example, if a given feature is generated at a certain frequency (e.g., hourly), the model training system may select, for example, the past twenty-four statuses as the set of statuses for validity of assessment of that feature. If another feature is generated at a different frequency (e.g., daily), the model training system may select, for example, the past seven statuses as the set of statuses for validity of assessment of that feature.

The model training system may generate a validity parameter for each feature that reflects the degree of validity of that feature. For example, the validity parameter may indicate whether a corresponding feature has high validity, medium validity, low validity, or some other degree of validity. In some embodiments, the model training system may generate the validity parameter based on successful statuses of the set of statuses for a given feature. For example, the model training system may determine the validity of a given feature by assessing the set of statuses for that feature (e.g., the past twenty-four statuses, the past seven statuses, etc.) and determine which statuses, out of that set, indicate successful completion. For example, the model training system may assess the ratio of successful to unsuccessful statuses, the portion of successful statuses, the relative timing of successful statuses, or other aspects of the set of statuses. As an example, the model training system may assign a high validity to features having at least 90% successful statuses out of the set, having successful statuses for the most recent ⅔ of the set of statuses, or using some other criteria. The model training system may use various criteria for assigning high, medium, low, or other validity parameters to each of the features.

In some embodiments, the validity parameters may work as a stateful system. For example, the system may store a validity map indicating different states of the validity parameter. The states may include high, medium-high, medium, medium-low, and low. The system may update those states based on the current state and corresponding statuses. That is, the states may be changed based on how successful feature generation attempts/processes are executed.

In some embodiments, the model training system may remove one or more features that are not valid enough from a dataset of the plurality of features. For example, if a first feature has a validity parameter that does not meet a threshold, the model training system may remove the first feature from the dataset.

In some embodiments, the model training system may generate a weight for each feature in the dataset based on the corresponding validity parameter of that feature. For example, the model training system may assign higher weights to features having higher validity parameters (e.g., higher degrees of validity). In some embodiments, the model training system may assign the weights proportionally to the validity parameters, using one or more thresholds, or in some other manner. The model training system assigns the corresponding weight to each feature within the dataset.

In some embodiments, the model training system may initialize the machine learning model. For example, the machine learning model may set its configurations (e.g., weights, biases, or other parameters) to initial values. In some embodiments, the model training system may input the dataset into a training routine of a machine learning model to train the machine learning model. For example, the dataset may train the machine learning model to make predictions based on degrees of validity of the features.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for training machine learning models based on feature validity, in accordance with one or more embodiments.

FIG. 2 illustrates a data structure storing log file locations for features, in accordance with one or more embodiments.

FIG. 3 illustrates a finite state map for validity parameters, in accordance with one or more embodiments.

FIG. 4 illustrates a data structure storing weighted features, in accordance with one or more embodiments.

FIG. 5 illustrates an exemplary machine learning model, in accordance with one or more embodiments.

FIG. 6 illustrates a computing device, in accordance with one or more embodiments.

FIG. 7 shows a flowchart of the process for training machine learning models based on feature validity, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

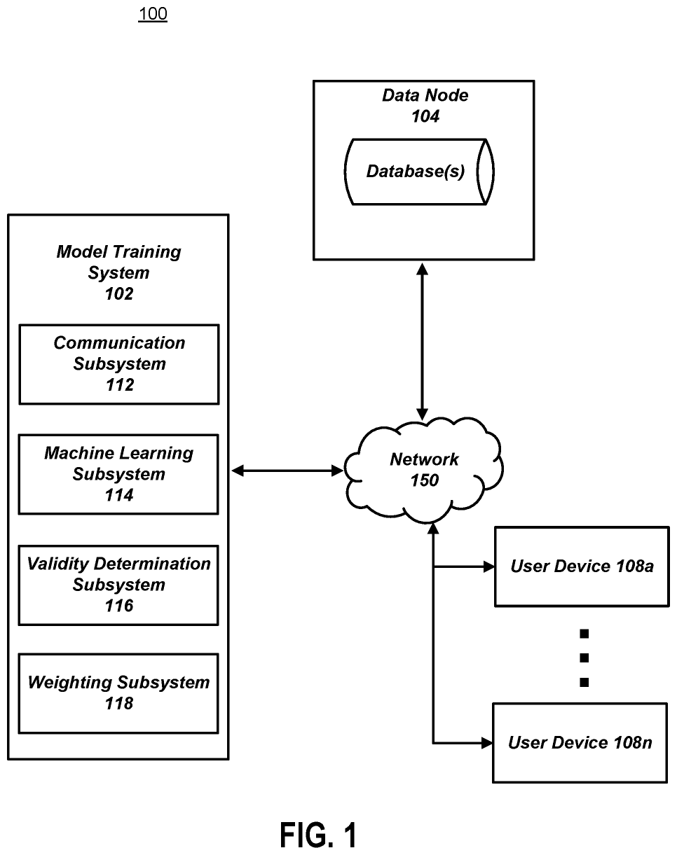

FIG. 1 shows an illustrative system 100 for training machine learning models based on feature validity, in accordance with one or more embodiments. System 100 may include model training system 102, data node 104, and user devices 108a-108n. Model training system 102 may include communication subsystem 112, machine learning subsystem 114, validity determination subsystem 116, weighting subsystem 118, and/or other subsystems. In some embodiments, only one user device may be used, while in other embodiments, multiple user devices may be used. The user devices 108a-108n may be associated with one or more users. The user devices 108a-108n may be associated with one or more user accounts. In some embodiments, user devices 108a-108n may be computing devices that may receive and send data via network 150. User devices 108a-108n may be end-user computing devices (e.g., desktop computers, laptops, electronic tablets, smartphones, and/or other computing devices used by end users). User devices 108a-108n may output (e.g., via a graphical user interface) communications, receive inputs, or perform other actions.

Model training system 102 may execute instructions for training machine learning models based on feature validity. Model training system 102 may include software, hardware, or a combination of the two. For example, communication subsystem 112 may include a network card (e.g., a wireless network card and/or a wired network card) that is associated with software to drive the card. In some embodiments, model training system 102 may be a physical server or a virtual server that is running on a physical computer system. In some embodiments, model training system 102 may be configured on a user device (e.g., a laptop computer, a smart phone, a desktop computer, an electronic tablet, or another suitable user device).

Data node 104 may store various data, including one or more machine learning models, training data, communications, feature generation logs, and/or other suitable data. In some embodiments, data node 104 may be used to train machine learning models. Data node 104 may include software, hardware, or a combination of the two. For example, data node 104 may be a physical server, or a virtual server that is running on a physical computer system. In some embodiments, model training system 102 and data node 104 may reside on the same hardware and/or the same virtual server/computing device. Network 150 may be a local area network, a wide area network (e.g., the Internet), or a combination of the two.

In some embodiments, model training system 102 (e.g., communication subsystem 112) may retrieve one or more feature generation logs. The feature generation logs may detail features selected to train a machine learning model as well as statuses reflecting the generation of those features. Generation of the features may entail periodic attempts to load new data to a file or dataset (or a portion of a file or dataset) associated with the feature. In some embodiments, communication subsystem 112 may receive new data associated with the features and may progressively add the new data to the file or dataset. Communication subsystem 112 may attempt to generate the features by attempting to retrieve data from one or more sources associated with the features. In some embodiments, communication subsystem 112 may receive the data from the one or more sources.

The feature generation logs may include a plurality of feature generation statuses for generating a plurality of features. For example, each feature generation status may indicate whether a corresponding attempt to generate a corresponding feature was successful. In some embodiments, success may be defined by varying measures. Success may be defined as a data upload to a feature dataset, such as population of a field in a file corresponding to a feature. In some embodiments, success may be defined as a data upload to a feature dataset, where the data type of the upload matches a data type specified for the feature. In some embodiments, success may be defined by other criteria. The status may indicate, for unsuccessful attempts, a reason why the attempt was not successful. For example, the status may indicate an error type associated with the unsuccessful attempt. In some embodiments, error types may indicate system outages or computational errors such as unavailability of new data, failure to load new data to or from a data source on time, or other computational errors.

As an example, communication subsystem 112 may retrieve feature generation logs for features relating to admission to a program. The features may include assignment grades, examination scores, rolling grade point average (GPA), attendance, and other relevant features. Model training system 102 may train a machine learning model to generate a prediction for whether an applicant will gain admission to the program based on these features. In some embodiments, communication subsystem 112 may retrieve a feature generation log relating to these features that details attempts to generate each feature. Communication subsystem 112 may attempt to retrieve or receive data relating to each feature from one or more sources. For example, communication subsystem 112 may retrieve or receive assignment grades for an applicant from a first source, examination scores for an applicant from a second source, rolling GPA for an applicant from a third source, and attendance for an applicant from a fourth source. In some embodiments, communication subsystem 112 may receive or retrieve data relating to the features from the same source. In some embodiments, communication subsystem 112 may receive or retrieve data relating to a single feature from multiple sources. In some embodiments, the feature generation logs may reflect the success or failure of each attempt to generate data for each feature.

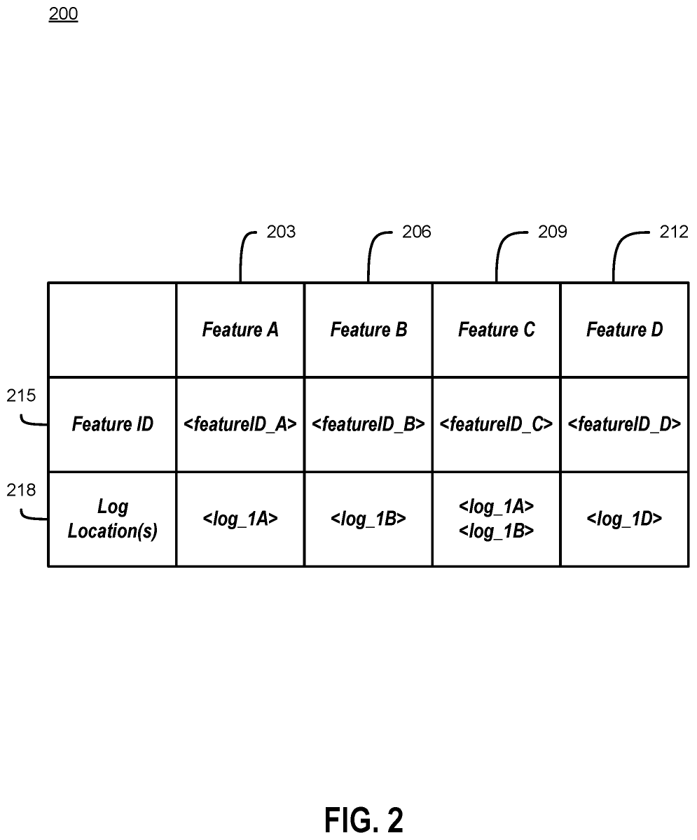

FIG. 2 illustrates a data structure 200 storing log file locations for features, in accordance with one or more embodiments. Data structure 200 may include feature 203, feature 206, feature 209, feature 212, or other features. Data structure 200 may include a feature ID 215 and a log location 218 for each feature. In some embodiments, data structure 200 may be a subset of a larger data structure. Each feature ID 215 may be an indicator used to identify the corresponding feature. Each log location 218 may be a path to a file location in which a feature generation log for a corresponding feature is located. The feature ID 215 may be used to look up a log location 218 of a given feature to locate a corresponding feature generation log, for example, to search for an error type within the corresponding feature generation log. In some embodiments, log location 218 may include more than one location. For example, as shown in FIG. 2, feature 209 may include two log locations. Feature 209 may be a transformation of a combination of two other features and may therefore rely on data from two sources. As an example, feature 209 may be a rolling GPA of an applicant, which may rely on both assignment grades (e.g., feature 203) and examination scores (e.g., feature 206). The log locations for feature 209 may therefore include the log location of feature 203 and the log location of feature 206.

Returning to FIG. 1, model training system 102 (e.g., validity determination subsystem 116) may determine a set of the statuses for assessing a validity of each feature. For example, each feature may be associated with a plurality of statuses, and the model training system may determine a subset of those statuses to use for validity assessment of that feature. In some embodiments, the model training system may determine the set of statuses for a given feature based on a frequency at which the model training system attempts to generate that feature. For example, a first feature (e.g., assignment grades) may be generated every hour, a second feature (e.g., examination scores) may be generated once a month, a third feature (e.g., rolling GPA) may be generated once a week, and a fourth feature (e.g., attendance) may be generated every day. Model training system 102 may select, as the set of statuses for each feature, a certain number of the statuses based on the respective frequency at which each feature is generated. For example, for a more frequent feature (e.g., hourly), model training system 102 may determine that the set of statuses should include more generation attempts (e.g., twenty-four). For a less frequent feature (e.g., monthly), model training system 102 may determine that the set of statuses should include fewer generation attempts (e.g., six).

Validity determination subsystem 116 may generate a corresponding validity parameter for each feature. The validity parameters may indicate a degree of validity for each corresponding feature. For example, the validity parameter may be expressed as discrete states (e.g., high validity, medium validity, low validity, etc.). In some embodiments, the validity parameter may be a score on a sliding scale (e.g., seven out of ten). In some embodiments, the validity parameter may be expressed as a percentage (e.g., 85% valid). Validity determination subsystem 116 may determine the validity of a given feature by assessing the set of statuses for that feature. For example, validity determination subsystem 116 may assess the set of feature generation statuses that was previously determined for a given feature (e.g., the previous twenty-four statuses). Validity determination subsystem 116 may then determine which statuses, out of the set, were successful.

In some embodiments, validity determination subsystem 116 may assess the portion of successful statuses or the ratio of successful to unsuccessful statuses. Validity determination subsystem 116 may determine, for each feature, a corresponding ratio of successful feature generation statuses to the total number of statuses in the corresponding set of feature generation statuses. As an example, validity determination subsystem 116 may determine that, for a first feature, twenty out of the previous twenty-four statuses indicate successful attempts (e.g., 5:6 ratio). Based on each corresponding ratio for each feature, validity determination subsystem 116 may generate a corresponding validity parameter for each feature. Validity determination subsystem 116 may determine, based on the 5:6 ratio, that the first feature has a high validity and may assign a validity parameter of “high” to the first feature.

In some embodiments, validity determination subsystem 116 may set various thresholds for determining whether a feature falls into high, medium, or low validity. For example, high validity may include any portion of successful attempts greater than or equal to 2:3, 66.67%, seven out of ten, or some other threshold. Medium validity may include any portion of successful attempts greater than 1:3, 33.33%, three out of ten, or some other threshold, but less than 2:3, 66.67%, or seven out of ten. Low validity may include any portions of successful attempts less than 1:3, 33.33%, three out of ten, or some other threshold. In some embodiments, validity determination subsystem 116 may assign additional validity parameters, each with additional thresholds, such as low-medium, medium-high, or other parameters. In some embodiments, for validity parameters that are continuous rather than discrete, validity determination subsystem 116 may generate the validity parameter for each feature by determining a proportional parameter based on the ratio or portion of successful attempts out of the set of statuses. If, for example, for a first feature, there were six successful attempts out of twenty-four, validity determination subsystem 116 may assign a validity parameter of 25% or 0.25.

In some embodiments, validity determination subsystem 116 may set thresholds stipulating a number of consecutive successful runs required for a feature to increase in validity. For example, validity determination subsystem 116 may specify that for a feature to increase in validity from low to medium, the previous two runs must be successful. Validity determination subsystem 116 may specify that for a feature to increase in validity from medium to high, the previous five runs must be successful. In some embodiments, validity determination subsystem 116 may adjust the thresholds for one or more features. For example, validity determination subsystem 116 may lower a threshold of successful statuses required for a feature to be scored as having high validity. This may reduce the time needed for a machine learning model to run if, for example, validity determination subsystem 116 has stipulated that all features must have a “high” validity.

In some embodiments, validity determination subsystem 116 may determine the validity parameters based on a relative timing or placement of successful statuses or other aspects of the set of statuses. For example, validity determination subsystem 116 may determine the placement of the successful and unsuccessful generation attempts within the set of statuses. For example, for a first feature, validity determination subsystem 116 may determine that the four unsuccessful generation attempts occurred early in the set of twenty-four statuses (e.g., the first four statuses). Validity determination subsystem 116 may determine not to penalize the first feature. On the other hand, if validity determination subsystem 116 determines that the four unsuccessful generation attempts occurred late in the set of twenty-four statuses (e.g., the most recent four), validity determination subsystem 116 may lower the validity of the first feature (e.g., to “medium”). In some embodiments, validity determination subsystem 116 may assess the set of feature generation attempts using multiple criteria. For example, validity determination subsystem 116 may generate an initial validity parameter for each feature and may adjust the validity based on the relative placements of the successful and unsuccessful attempts within the set of statuses.

In some embodiments, validity determination subsystem 116 may generate the validity parameters based on a type of error associated with unsuccessful generation attempts. For example, validity determination subsystem 116 may determine, based on the one or more feature generation logs, a first error type associated with a first feature generation attempt for a first feature. In some embodiments, validity determination subsystem 116 may look up a feature ID and associated log location, as shown in FIG. 2. The log location may include a path or pointer to a feature generation log, which may store information about the error types of each unsuccessful generation attempt. Error types may indicate various causes of unsuccessful feature generations, such as system outages at a source or computation errors, such as lack of new data, failure to load data into a data source on time, or other errors.

Validity determination subsystem 116 may generate different validity parameters based on different error types. In some embodiments, validity determination subsystem 116 may adjust validity parameters based on the error types. For example, validity determination subsystem 116 may generate, based on a first error type, a first validity parameter for a first feature and may generate, based on a second error type (e.g., different from the first error type), a second validity parameter for a second feature. In some embodiments, if the first error type indicates a computational error such as a lack of new data for the first feature, validity determination subsystem 116 may not penalize the first feature or may generate a higher validity parameter for the first feature. For example, the first error type may indicate that there have been no new assignment grades since the last feature generation. In some embodiments, if the second error type indicates an update failure for the second feature, validity determination subsystem 116 may penalize the second feature or may generate a lower validity parameter for the second feature. For example, the second error type may indicate that the second feature (e.g., examination scores) is broken.

In some embodiments, a first feature of the plurality of features may be a transformation of a combination of a second feature and a third feature of the plurality of features. For example, a transformation may create new features using the existing features. Transformations may involve applying functions to the data of the second and third features to generate the first feature. As an example, a feature representing an applicant's GPA may be a transformation of other features, such as assignment grades and examination scores. Validity determination subsystem 116 may apply a function to an applicant's assignment grades and examination scores to generate the applicant's GPA. For a first feature that is a combination of two other features, validity determination subsystem 116 may assign, to the first feature, a first validity parameter based on a second validity parameter associated with the second feature and a third validity parameter associated with the third feature. The validity parameter of the first feature is therefore dependent on the validity parameters of the second and third features. If a validity of the second or third features changes, the validity of the first feature also changes.

In some embodiments, validity determination subsystem 116 may determine, based on the one or more feature generation logs, that a set of feature generation statuses for a first feature of the plurality of features has changed. For example, communication subsystem 112 may receive new feature generation statuses for the first feature and may determine that a status has changed from successful to unsuccessful or from unsuccessful to successful. For example, an applicant's assignment grades may fail to generate for the relevant feature. Validity determination subsystem 116 may retrieve a first validity parameter associated with the first feature so that validity determination subsystem 116 can update the first validity parameter to reflect the change. Validity determination subsystem 116 may also retrieve a state map for updating the first validity parameter. Validity determination subsystem 116 may update the first validity parameter and the state map based on a change to the feature generation statuses.

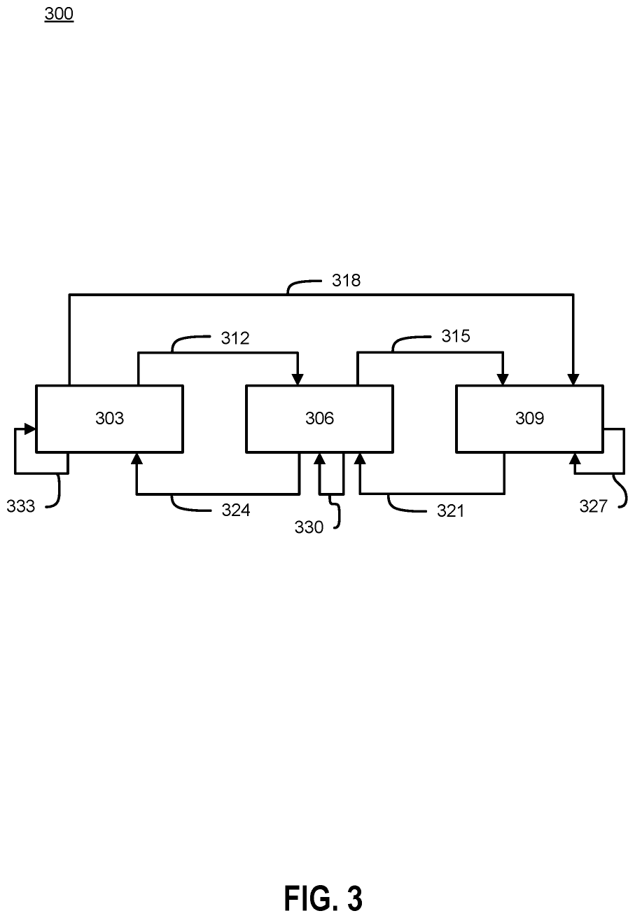

FIG. 3 illustrates a finite state map 300 for validity parameters, in accordance with one or more embodiments. Validity determination subsystem 116 may use finite state map 300 for determining changes of validity parameters in features due to certain circumstances. In some embodiments, finite state map 300 may include multiple states (e.g., validity parameters) and transitions between the states. For example, finite state map 300 may include high validity 303, medium validity 306, and low validity 309. In some embodiments, finite state map 300 may include additional states (e.g., validity parameters), and finite state map 300 may represent a subset of the entire map. In some embodiments, each feature may have a different finite state map. For example, for a binary feature (e.g., yes or no), the state map may have two states. For a categorical feature (e.g., high, medium, low), the state map may have three states, as shown in FIG. 3. In some embodiments, features may have state maps with additional states.

The transitions between states may represent a change of state (e.g., change in validity parameter) in response to certain criteria being satisfied. For example, transition 312 may occur in response to a feature with a high validity experiencing an unsuccessful generation attempt. Transition 312 may represent a change from high validity to medium validity. In some embodiments, transition 318 may occur in response to a feature with a high validity experiencing one or more unsuccessful generation attempts. Transition 318 may represent a change from high validity to low validity. For example, validity determination subsystem 116 may specify that a single unsuccessful generation attempt changes a high validity to medium validity, or validity determination subsystem 116 may specify that a single unsuccessful generation attempt changes a high validity to low validity. In some embodiments, validity determination subsystem 116 may use other criteria to determine which transition to follow, for example, based on error type associated with the unsuccessful generation attempts. Transition 315 may represent a change from medium validity to low validity. In some embodiments, transition 315 may occur in response to a feature with a medium validity experiencing an unsuccessful generation attempt.

Transition 321 may occur in response to a feature with a low validity experiencing a successful generation attempt. Transition 321 may represent a change from low validity to medium validity. Transition 324 may occur in response to a feature with medium validity experiencing a threshold number of successful generation attempts. For example, transition 324 may represent a feature with medium validity experiencing the fifth of five consecutive successful feature generation attempts. Transition 321 may represent a change from medium validity to high validity.

Transition 327 may represent a feature with a low validity experiencing another unsuccessful generation attempt. Transition 321 may represent no change in state. Transition 333 may represent a feature with high validity experiencing another successful generation attempt. Transition 333 may represent no change in state. Transition 330 may represent a feature with low validity experiencing a successful generation attempt without achieving the threshold number of consecutive successful generation attempts required for transition 324. For example, transition 330 may represent a successful generation attempt without all five (or other threshold number) of the most recent generation attempts being successful.

Returning to FIG. 1, validity determination subsystem 116 may determine whether a first validity parameter associated with a first feature meets a validity threshold. For example, a validity threshold may be a minimum of medium validity, 33.33%, 3:10, or some other threshold. If the first validity parameter of the first feature does not meet the validity threshold, validity determination subsystem 116 may remove the first feature from a dataset. For example, the dataset may be a dataset of the plurality of features for input into a machine learning model for training the machine learning model. Removing the first feature from the dataset may ensure that the machine learning model is not trained using the first feature. As an example, validity determination subsystem 116 may determine that a feature representing applicants' attendance record has a low validity that does not meet a requisite threshold. Validity determination subsystem 116 may thus remove the feature representing attendance from the dataset.

In some embodiments, validity determination subsystem 116 may determine that one or more features have corresponding validity parameters that do not meet a validity threshold. As discussed above, the validity threshold may be a minimum of medium validity, 33.33%, 3:10, or some other value. Validity determination subsystem 116 may update the dataset for the one or more features having validity parameters that do not meet the validity threshold. For example, validity determination subsystem 116 may update the dataset to include historic values for those features. The historic values may be values generated for those features prior to an event that caused the validity of those features to drop. For example, a system outage or system failure may have caused the feature representing attendance to lose validity and new data representing attendance is no longer reliable. Validity determination subsystem 116 may thus update the dataset to include historic values for attendance and exclude invalid values for the attendance feature that may have been generated after the failure event.

Model training system 102 (e.g., weighting subsystem 118) may generate, based on each corresponding validity parameter, a corresponding weight for each feature of the plurality of features. For example, the model training system may assign higher weights to features having higher validity parameters (e.g., higher degrees of validity). In some embodiments, the model training system 102 may assign the weights proportionally to the validity parameters, using one or more thresholds, or in some other manner. The model training system may assign the corresponding weight to each feature within the dataset.

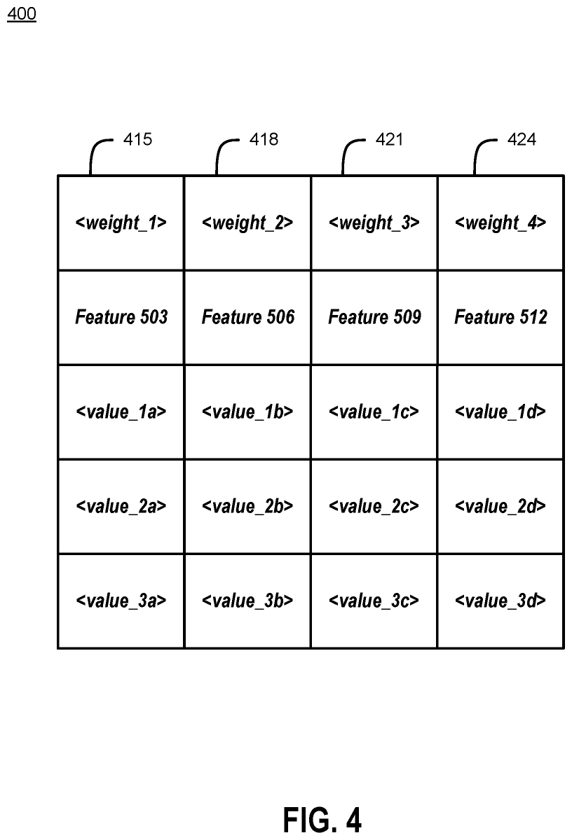

FIG. 4 illustrates a data structure 400 storing weighted features, in accordance with one or more embodiments. In some embodiments, data structure 400 may include feature 503, feature 506, feature 509, and feature 512, as well as values associated with each of the features. In some embodiments, feature 503 may represent assignment grades, feature 506 may represent examination scores, feature 509 may represent rolling GPA, and feature 512 may represent attendance. In some embodiments, data structure 400 may include additional columns or rows. For example, data structure 400 may represent a subset of a larger data structure. In some embodiments, data structure may include weight 415, weight 418, weight 421, and weight 424. Weight 415, weight 418, weight 421, and weight 424 may be assigned, respectively, to feature 503, feature 506, feature 509, and feature 512 based on the corresponding validity parameters of each feature.

In some embodiments, to assign the weights to the features, weighting subsystem 118 may determine threshold validity degrees for each feature. For example, weighting subsystem 118 may determine a corresponding validity threshold for each feature based on a corresponding frequency of feature generation attempts for each feature. As an example, based on the frequency of generation for a given feature (e.g., hourly, daily, weekly, etc.), weighting subsystem 118 may set a threshold validity for that feature. In some embodiments, weighting subsystem 118 may set a higher threshold for more frequently generated features than less frequently generated features. In some embodiments, weighting subsystem 118 may set a lower threshold for more frequently generated features than less frequently generated features. In some embodiments, weighting subsystem 118 may rely on other criteria for setting the threshold validity for the features. In response to determining that a first validity parameter for a first feature of the plurality of features meets a first validity threshold for the first feature, weighting subsystem 118 may assign a first weight to the first feature. In response to determining that a second validity parameter for a second feature of the plurality of features does not meet a second validity threshold for the second feature, weighting subsystem 118 may assign a second weight to the second feature. The first weight may be higher than the second weight. In some embodiments, each feature may have multiple threshold validity levels corresponding to multiple weights.

In some embodiments, weighting subsystem 118 may retrieve a first state map associated with a first feature of the plurality of features, such as finite state map 300, as shown in FIG. 3. For example, each feature of the plurality of features may be associated with a state map of a plurality of state maps. In response to determining that a first validity parameter for a first feature matches a first state of the first state map (e.g., medium validity 306), weighting subsystem 118 may assign a first weight to the first feature. In response to determining that a second validity parameter for the first feature matches a second state of the state map (e.g., high validity 303), weighting subsystem 118 may assign a second weight to the first feature. In some embodiments, the second weight may be higher than the first weight and the second state may indicate higher validity than the first state. In some embodiments, weighting subsystem 118 may determine a location of the validity parameter within the state map and may generate a weight for the feature based on the location of the validity parameter within the state map. For example, weighting subsystem 118 may assign weights that correspond to the various states in finite state map 300. If the validity parameter is located at high validity 303, weighting subsystem 118 may assign a certain weight (e.g., a high weight). If the validity parameter is located at medium validity 306, weighting subsystem 118 may assign a certain weight (e.g., an intermediate weight). If the validity parameter is located at low validity 309, weighting subsystem 118 may assign a certain weight (e.g., a low weight).

Once weighting subsystem 118 has weighted the features within the dataset (e.g., data structure 400, as shown in FIG. 4), model training system 102 (e.g., machine learning subsystem 114) may input the dataset into a training routine of a machine learning model. The dataset may cause the training routine to train the machine learning model based on weights of the plurality of features. For example, the training routine may use the weights to indicate feature importance within the machine learning model. In some embodiments, the model training system may initialize the machine learning model. For example, the machine learning model may set its configurations (e.g., weights, biases, or other parameters) to initial values.

Model training system 102 (e.g., machine learning subsystem 114) may include or manage one or more machine learning models. For example, one or more machine learning models may be trained to generate predictions for entries based on corresponding features. Machine learning subsystem 114 may include software components, hardware components, or a combination of both. For example, machine learning subsystem 114 may include software components (e.g., API calls) that access one or more machine learning models. Machine learning subsystem 114 may access training data, for example, in memory. In some embodiments, machine learning subsystem 114 may access the training data on data node 104 or on user devices 108a-108n. In some embodiments, the training data may include entries with corresponding features and corresponding output labels for the entries. In some embodiments, machine learning subsystem 114 may access one or more machine learning models. For example, machine learning subsystem 114 may access the machine learning models on data node 104 or on user devices 108a-108n.

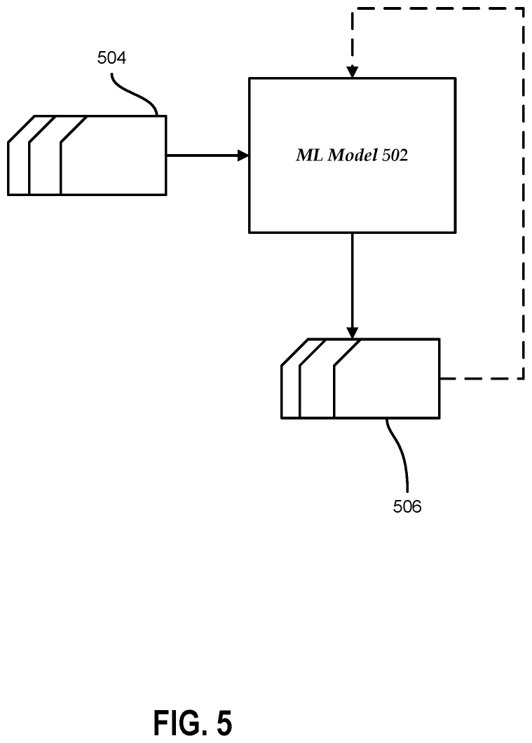

FIG. 5 illustrates an exemplary machine learning model 502, in accordance with one or more embodiments. The machine learning model may be trained using features such as application materials, scores, applicant attributes, references, or other features associated with applicants for admission to a particular program. The machine learning model may be trained to predict whether the applicants will be admitted to the program based on the features associated with the applicants. In some embodiments, machine learning model 502 may be included in machine learning subsystem 114 or may be associated with machine learning subsystem 114. Machine learning model 502 may take input 504 (e.g., features corresponding to applicants, as described in greater detail with respect to FIG. 4) and may generate outputs 506 (e.g., predictions). The output parameters may be fed back to the machine learning model as inputs to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or a supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

In some embodiments, machine learning subsystem 114 may configure the machine learning model to cease operation when one or more features do not meet a certain validity threshold. For example, machine learning subsystem 114 may configure the machine learning model to cease running when one feature or a portion of features does not meet a high validity threshold. The machine learning model may resume operation when those features return to high validity states.

In some embodiments, communication subsystem 112 may generate alerts in response to certain events. For example, communication subsystem 112 may generate an alert if a feature drops below a certain validity threshold. Communication subsystem 112 may generate an alert if a portion of the features drops below a certain validity threshold. Communication subsystem 112 may generate an alert if the machine learning model ceases operation, such as in the example above.

In some embodiments, machine learning subsystem 114 may determine a residual value for the machine learning model once it has been trained. For example, a residual value may be a difference (e.g., percentage) between observed and predicted values of data. A residual value may, for example, be 7% if the machine learning model correctly predicts program admission of 93% of applicants. Machine learning subsystem 114 may determine whether the residual value meets a residual threshold. For example, a residual threshold is a maximum residual value that is permitted. A residual threshold may be, for example, 5%. In the example above, the residual value of 7% meets the residual threshold of 5%. In response to determining that the residual value meets the residual threshold, weighting subsystem 118 may adjust the corresponding weights of the plurality of features. For example, the high residual value may be an indication that the weights were set too drastically. Weighting subsystem 118 may thus adjust the weights to make the weights less drastic and improve the accuracy of the machine learning model.

In some embodiments, communication subsystem 112 may detect a new plurality of feature generation statuses within the one or more feature generation logs. For example, one or more of the features may be updated with new attempts to generate the features. Validity determination subsystem 116 may determine, based on the new plurality of feature generation statuses, that a first feature generation status for a first feature has changed. For example, a validity of a first feature representing examination scores may have previously been high, but the new feature generation status may reflect an unsuccessful attempt to generate the first feature. As such, the first feature representing examination scores may drop to medium. Validity determination subsystem 116 may modify a first validity parameter for the first feature accordingly, based on the first feature generation status. Weighting subsystem 118 may adjust, within the dataset, based on the first validity parameter, a first weight for the first feature. For example, weighting subsystem 118 may weigh the first feature less heavily based on the drop in validity of the first feature. Machine learning subsystem 114 may then update the machine learning model based on the first weight of the first feature within the dataset. For example, machine learning subsystem 114 may input the updated dataset into the machine learning model to cause the machine learning model to update its configurations based on the adjusted weights.

### Computing Environment

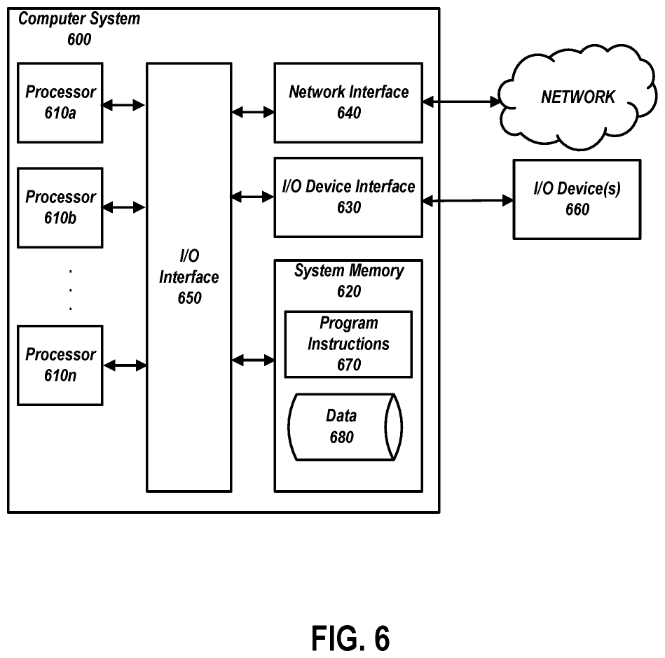

FIG. 6 shows an example computing system 600 that may be used in accordance with some embodiments of this disclosure. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example, an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative, and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a user device, a mobile telephone, a personal digital assistant (PDA), a mobile audio or video player, a game console, a vehicle-mounted computer, a Global Positioning System (GPS), or the like. Computing system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

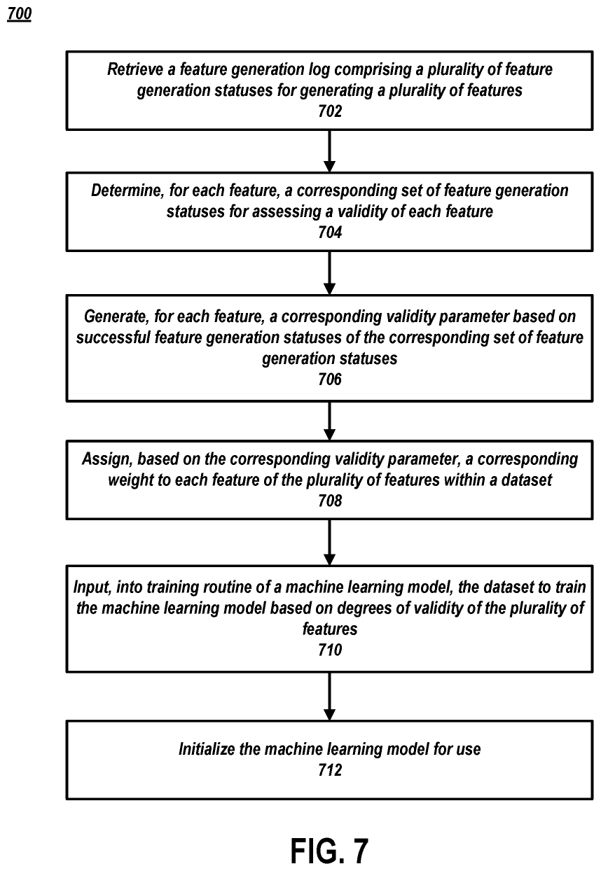

FIG. 7 shows a flowchart of the process 700 for training machine learning models based on feature validity, in accordance with one or more embodiments. For example, the system may use process 700 (e.g., as implemented on one or more system components described above) to generate validity parameters for weighting features used to train machine learning models.

At 702, model training system 102 (e.g., using one or more of processors 610a-610n) may retrieve a feature generation log comprising a plurality of feature generation statuses for generating a plurality of features. For example, each feature generation status may indicate whether a corresponding feature generation attempt was successful or unsuccessful. In some embodiments, model training system 102 may retrieve the feature generation log from system memory 620, via the network, or elsewhere.

At 704, model training system 102 (e.g., using one or more of processors 610a-610n) may determine, based on the plurality of feature generation statuses, a corresponding set of feature generation statuses for assessing a validity of each feature. For example, the corresponding set may be a subset of the plurality of feature generation statuses that are associated with the feature. In some embodiments, each corresponding set may be based on a frequency of corresponding feature generation attempts for each feature. In some embodiments, model training system 102 may determine the corresponding set of feature generation statuses using one or more of processors 610a-610n.

At 706, model training system 102 (e.g., using one or more of processors 610a-610n) may generate, for each feature, a corresponding validity parameter. In some embodiments, each corresponding validity parameter may be based on successful feature generation statuses of the corresponding set of feature generation statuses. In some embodiments, model training system 102 may generate the corresponding validity parameters using one or more of processors 610a-610n.

At 708, model training system 102 (e.g., using one or more of processors 610a-610n) may assign, based on the corresponding validity parameter, a corresponding weight to each feature of the plurality of features. In some embodiments, model training system 102 may assign the corresponding weights to the plurality of features within a dataset. For example, model training system 102 may update or generate a dataset to include, for each feature, the corresponding weight. In some embodiments, model training system 102 may assign the corresponding weights using one or more of processors 610a-610n.

At 710, model training system 102 (e.g., using one or more of processors 610a-610n) may input, into a training routine of a machine learning model, the dataset to train the machine learning model based on degrees of validity of the plurality of features. For example, training the machine learning model may cause the machine learning model to set its configurations (e.g., weights, biases, or other parameters) to rely more heavily on features with higher corresponding weights (e.g., entries having higher degrees of validity). In some embodiments, model training system 102 may input the dataset into the machine learning model using one or more of processors 610a-610n.

At 712, model training system 102 (e.g., using one or more of processors 610a-610n) may initialize the machine learning model for use. In some embodiments, model training system 102 may initialize the machine learning model using one or more of processors 610a-610n.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising retrieving one or more feature generation logs comprising a plurality of feature generation statuses for generating a plurality of features, wherein each feature generation status indicates whether a corresponding feature generation attempt was successful, determining, for each of the plurality of features based on the plurality of feature generation statuses, a corresponding subset of feature generation statuses for assessing a validity of each of the plurality of features, generating, for each of the plurality of features, a corresponding validity parameter based on successful feature generation statuses of the corresponding subset of feature generation statuses, wherein each corresponding validity parameter indicates a degree of validity of each corresponding feature, generating, based on each corresponding validity parameter, a corresponding weight for each of the plurality of features, assigning, to each of the plurality of features within a dataset, the corresponding weight, inputting, into a training routine of a machine learning model, the dataset to train the machine learning model to make predictions based on degrees of validity of the plurality of features, and initializing the machine learning model for use.
2. The method of any one of the preceding embodiments, further comprising determining whether a first validity parameter associated with a first feature of the plurality of features meets a validity threshold, and based on determining that the first validity parameter associated with the first feature of the plurality of features does not meet the validity threshold, removing the first feature from the plurality of features within the dataset.
3. The method of any one of the preceding embodiments, further comprising determining, based on the one or more feature generation logs, that a subset of feature generation statuses for a first feature of the plurality of features has changed, retrieving a first validity parameter associated with the first feature and a state map for updating the first validity parameter, and updating, based on a change within the subset of feature generation statuses, the first validity parameter and the state map.
4. The method of any one of the preceding embodiments, wherein assigning the corresponding weight to each of the plurality of features further comprises determining a corresponding validity threshold for each of the plurality of features based on a corresponding frequency of feature generation attempts for each of the plurality of features, in response to determining that a first validity parameter for a first feature of the plurality of features meets a first validity threshold, assigning a first weight to the first feature, and in response to determining that a second validity parameter for a second feature of the plurality of features does not meet a second validity threshold, assigning a second weight to the second feature, wherein the first weight is higher than the second weight.
5. The method of any one of the preceding embodiments, wherein generating the corresponding weight for each of the plurality of features comprises retrieving a first validity parameter for a first feature of the plurality of features and a state map, determining a location of the first validity parameter within the state map, and generating a first weight for the first feature based on the location of the first validity parameter within the state map.
6. The method of any one of the preceding embodiments, further comprising retrieving a first state map associated with a first feature of the plurality of features, wherein each of the plurality of features is associated with a state map of a plurality of state maps, in response to determining that a first validity parameter for a first feature matches a first state of the first state map, assigning a first weight to the first feature, and in response to determining that a second validity parameter for the first feature matches a second state of the state map, assigning a second weight to the first feature, wherein the second weight is higher than the first weight and the second state indicates higher validity than the first state.
7. The method of any one of the preceding embodiments, further comprising detecting a new plurality of feature generation statuses within the one or more feature generation logs, determining, based on the new plurality of feature generation statuses, that a first feature generation status for a first feature has changed, modifying a first validity parameter for the first feature based on the first feature generation status, adjusting, within the dataset, based on the first validity parameter, a first weight for the first feature, and updating the machine learning model based on the first weight of the first feature within the dataset.
8. The method of any one of the preceding embodiments, wherein generating, for each of the plurality of features, the corresponding validity parameter further comprises determining, based on the one or more feature generation logs, a first error type associated with a first feature generation attempt for a first feature, generating, based on the first error type, a first validity parameter for the first feature, determining, based on the one or more feature generation logs, a second error type associated with a second feature generation attempt for a second feature, and generating, based on the second error type, a second validity parameter for the second feature, wherein the first validity parameter is different from the second validity parameter.
9. The method of any one of the preceding embodiments, further comprising determining that the first error type indicates a lack of new data for the first feature and the second error type indicates an update failure for the second feature, and assigning the first validity parameter to the first feature and the second validity parameter to the second feature, wherein the first validity parameter indicates a higher degree of validity than the second validity parameter.
10. The method of any one of the preceding embodiments, wherein a first feature of the plurality of features comprises a transformation of a combination of a second feature and a third feature of the plurality of features, and further comprising assigning, to the first feature, a first validity parameter based on a second validity parameter associated with the second feature and a third validity parameter associated with the third feature.
11. The method of any one of the preceding embodiments, wherein generating the corresponding validity parameter for each of the plurality of features comprises determining, for each of the plurality of features, a corresponding ratio of the successful feature generation statuses to the corresponding subset of feature generation statuses, and based on the corresponding ratio for each of the plurality of features, generating the corresponding validity parameter for each of the plurality of features.
12. The method of any one of the preceding embodiments, further comprising, for one or more features having one or more corresponding validity parameters not meeting a validity threshold, updating the dataset with one or more corresponding sets of historic values for the one or more features, wherein the one or more corresponding sets of historic values are associated with one or more corresponding historic validity parameters meeting the validity threshold.
13. The method of any one of the preceding embodiments, further comprising determining a residual value for the machine learning model, determining whether the residual value meets a residual threshold, and in response to determining that the residual value meets the residual threshold, adjusting corresponding weights of the plurality of features.
14. A tangible, non-transitory, machine-readable medium storing instructions that, when executed by a data processing apparatus, cause the data processing apparatus to perform operations comprising those of any of embodiments 1-13.
15. A system comprising one or more processors and memory storing instructions that, when executed by the processors, cause the processors to effectuate operations comprising those of any of embodiments 1-13.
16. A system comprising means for performing any of embodiments 1-13.
17. A system comprising cloud-based circuitry for performing any of embodiments 1-13.

What is claimed is:

1. A system for training machine learning models based on feature validity, the system comprising:
one or more processors and one or more memories having computer-executable instructions stored thereon, the computer-executable instructions, when executed by the one or more processors, causing the system to perform operations comprising:
retrieving a feature generation log comprising a plurality of feature generation statuses for generating a plurality of features, wherein each feature generation status indicates whether a corresponding feature generation attempt was successful or unsuccessful;
determining, for each of the plurality of features based on the plurality of feature generation statuses, a corresponding subset of feature generation statuses for assessing a validity of each of the plurality of features, wherein each corresponding subset is based on a frequency of corresponding feature generation attempts for each of the plurality of features;
determining, for each of the plurality of features, a corresponding ratio of successful feature generation statuses to the corresponding subset of feature generation statuses;
based on each corresponding ratio for each of the plurality of features, generating a corresponding validity parameter for each of the plurality of features, wherein each corresponding validity parameter indicates a degree of success of the corresponding feature generation attempts for each of the plurality of features;
assigning a corresponding weight to each of the plurality of features within a dataset, wherein the corresponding weight reflects the corresponding validity parameter for each of the plurality of features, and wherein higher weights are assigned to features having higher ratios of successful generation attempts;
inputting, into a training routine of a machine learning model, the dataset to train the machine learning model based on weights of the plurality of features, wherein the training routine uses the weights to indicate feature importance within the machine learning model; and
initializing the machine learning model for use.

2. A method comprising:
retrieving one or more feature generation logs comprising a plurality of feature generation statuses for generating a plurality of features, wherein each feature generation status indicates whether a corresponding feature generation attempt was successful;
determining, for each of the plurality of features based on the plurality of feature generation statuses, a corresponding subset of feature generation statuses for assessing a validity of each of the plurality of features;
generating, for each of the plurality of features, a corresponding validity parameter based on successful feature generation statuses of the corresponding subset of feature generation statuses, wherein each corresponding validity parameter indicates a degree of validity of each corresponding feature;
generating, based on each corresponding validity parameter, a corresponding weight for each of the plurality of features;
assigning, to each of the plurality of features within a dataset, the corresponding weight;
inputting, into a training routine of a machine learning model, the dataset to train the machine learning model to make predictions based on degrees of validity of the plurality of features; and
initializing the machine learning model for use.

3. The method of claim 2, further comprising:
determining whether a first validity parameter associated with a first feature of the plurality of features meets a validity threshold; and
based on determining that the first validity parameter associated with the first feature of the plurality of features does not meet the validity threshold, removing the first feature from the plurality of features within the dataset.

4. The method of claim 2, further comprising:
determining, based on the one or more feature generation logs, that a subset of feature generation statuses for a first feature of the plurality of features has changed;
retrieving a first validity parameter associated with the first feature and a state map for updating the first validity parameter; and
updating, based on a change within the subset of feature generation statuses, the first validity parameter and the state map.

5. The method of claim 2, wherein assigning the corresponding weight to each of the plurality of features further comprises:
determining a corresponding validity threshold for each of the plurality of features based on a corresponding frequency of feature generation attempts for each of the plurality of features;
in response to determining that a first validity parameter for a first feature of the plurality of features meets a first validity threshold, assigning a first weight to the first feature; and
in response to determining that a second validity parameter for a second feature of the plurality of features does not meet a second validity threshold, assigning a second weight to the second feature, wherein the first weight is higher than the second weight.

6. The method of claim 2, wherein generating the corresponding weight for each of the plurality of features comprises:
retrieving a first validity parameter for a first feature of the plurality of features and a state map;
determining a location of the first validity parameter within the state map; and
generating a first weight for the first feature based on the location of the first validity parameter within the state map.

7. The method of claim 2, further comprising:
retrieving a first state map associated with a first feature of the plurality of features, wherein each of the plurality of features is associated with a state map of a plurality of state maps;
in response to determining that a first validity parameter for a first feature matches a first state of the first state map, assigning a first weight to the first feature; and
in response to determining that a second validity parameter for the first feature matches a second state of the state map, assigning a second weight to the first feature, wherein the second weight is higher than the first weight and the second state indicates higher validity than the first state.

8. The method of claim 2, further comprising:
detecting a new plurality of feature generation statuses within the one or more feature generation logs;
determining, based on the new plurality of feature generation statuses, that a first feature generation status for a first feature has changed;
modifying a first validity parameter for the first feature based on the first feature generation status;
adjusting, within the dataset, based on the first validity parameter, a first weight for the first feature; and
updating the machine learning model based on the first weight of the first feature within the dataset.

9. The method of claim 2, wherein generating, for each of the plurality of features, the corresponding validity parameter further comprises:
determining, based on the one or more feature generation logs, a first error type associated with a first feature generation attempt for a first feature;
generating, based on the first error type, a first validity parameter for the first feature;
determining, based on the one or more feature generation logs, a second error type associated with a second feature generation attempt for a second feature; and
generating, based on the second error type, a second validity parameter for the second feature, wherein the first validity parameter is different from the second validity parameter.

10. The method of claim 9, further comprising:
determining that the first error type indicates a lack of new data for the first feature and the second error type indicates an update failure for the second feature; and
assigning the first validity parameter to the first feature and the second validity parameter to the second feature, wherein the first validity parameter indicates a higher degree of validity than the second validity parameter.

11. The method of claim 2, wherein a first feature of the plurality of features comprises a transformation of a combination of a second feature and a third feature of the plurality of features, and further comprising assigning, to the first feature, a first validity parameter based on a second validity parameter associated with the second feature and a third validity parameter associated with the third feature.

12. The method of claim 2, wherein generating the corresponding validity parameter for each of the plurality of features comprises:
determining, for each of the plurality of features, a corresponding ratio of the successful feature generation statuses to the corresponding subset of feature generation statuses; and
based on the corresponding ratio for each of the plurality of features, generating the corresponding validity parameter for each of the plurality of features.

13. The method of claim 2, further comprising, for one or more features having one or more corresponding validity parameters not meeting a validity threshold, updating the dataset with one or more corresponding sets of historic values for the one or more features, wherein the one or more corresponding sets of historic values are associated with one or more corresponding historic validity parameters meeting the validity threshold.

14. The method of claim 2, further comprising:
determining a residual value for the machine learning model;
determining whether the residual value meets a residual threshold; and
in response to determining that the residual value meets the residual threshold, adjusting corresponding weights of the plurality of features.

15. One or more non-transitory, computer-readable media storing instructions that when executed by one or more processors cause the one or more processors to perform operations comprising:
retrieving a first feature generation log comprising a plurality of first feature generation statuses for a first feature of a plurality of features, wherein the plurality of first feature generation statuses associated with the first feature indicates whether each first feature generation attempt was successful;
determining, for the first feature based on the plurality of first feature generation statuses, a first subset of the plurality of first feature generation statuses for assessing a first validity of the first feature;
generating, for the first feature, a first validity parameter based on successful feature generation statuses of the first subset of the plurality of first feature generation statuses, wherein the first validity parameter indicates the first validity of the first feature;
removing, from the plurality of features within a dataset, the first feature based on the first validity parameter not meeting a validity threshold;
inputting, into a training routine of a machine learning model, the dataset to train the machine learning model; and
initializing the machine learning model for use.

16. The one or more non-transitory, computer-readable media of claim 15, wherein the instructions further cause the one or more processors to perform operations comprising:
retrieving a plurality of feature generation logs comprising a plurality of feature generation statuses for generating one or more remaining features of the plurality of features, wherein each feature generation status indicates whether a corresponding feature generation attempt was successful;
determining, for the one or more remaining features of the plurality of features based on a plurality of feature generation statuses, a corresponding subset of feature generation statuses for assessing validity of each of the plurality of features of the one or more remaining features;
generating, for each of the plurality of features of the one or more remaining features, a corresponding validity parameter based on successful feature generation statuses of the corresponding subset of feature generation statuses;
generating, based on each corresponding validity parameter, a corresponding weight for each of the plurality of features of the one or more remaining features;
assigning, to each of the plurality of features of the one or more remaining features within the dataset, the corresponding weight; and
updating the dataset based on corresponding weights of the one or more remaining features.

17. The one or more non-transitory, computer-readable media of claim 16, wherein, to generate, for each of the plurality of features, the corresponding validity parameter, the instructions further cause the one or more processors to perform operations comprising:
determining, based on the plurality of feature generation logs, a first error type associated with a second feature generation attempt for a second feature;
generating, based on the first error type, a second validity parameter for the second feature;
determining, based on the plurality of feature generation logs, a second error type associated with a third feature generation attempt for a third feature; and
generating, based on the second error type, a third validity parameter for the third feature, wherein the second validity parameter is different from the third validity parameter.

18. The one or more non-transitory, computer-readable media of claim 17, wherein the instructions further cause the one or more processors to perform operations comprising:
determining that the first error type indicates a lack of new data for the second feature and the second error type indicates an update failure for the third feature; and
assigning the second validity parameter to the second feature and the third validity parameter to the third feature, wherein the second validity parameter indicates a higher degree of validity than the third validity parameter.

19. The one or more non-transitory, computer-readable media of claim 15, wherein a second feature of the plurality of features comprises a transformation of a combination of a third feature and a fourth feature of the plurality of features, and wherein the instructions further cause the one or more processors to perform operations comprising assigning, to the second feature, a second validity parameter based on a third validity parameter associated with the third feature and a fourth validity parameter associated with the fourth feature.

20. The one or more non-transitory, computer-readable media of claim 15, wherein, to generate the first validity parameter for the first feature, the instructions further cause the one or more processors to perform operations comprising:
determining, for the first feature, a first ratio of the successful feature generation statuses to the first subset of the plurality of first feature generation statuses; and
based on the first ratio, generating the first validity parameter for the first feature.
